(19) United States
(12) Patent Application Publication
(10) Pub. No.: US 2025/0061466 A1
(43) Pub. Date: Feb. 20, 2025

(54) SYSTEM AND METHOD FOR EMPLOYMENT HISTORY VERIFICATION

(71) Applicant: Blagojche Paskoski, Romeoville, IL (US)

(72) Inventor: Blagojche Paskoski, Romeoville, IL (US)

(21) Appl. No.: 18/235,166

(22) Filed: Aug. 17, 2023

(51) Int. Cl. G06Q 30/018

(52) U.S. Cl. CPC G06Q 30/018

(57) ABSTRACT

A computer system and method for employment history verification is provided for commercial trucking industry operating under government regulations. The system allows a carrier employer to verify the employment record of a driver candidate in an integrated platform. The system comprises driver module, carrier module, and operation module in a platform. Once the carrier employer initiates the verification process with the approval of the driver candidate, the system will take over the verification process keeping track of the progress of the verification processes, encouraging non-responding employer to respond, and recording all activities of the verification process for government regulation audits.

### BACKGROUND OF THE INVENTION

The present invention relates generally to a computer system and method for employment history verification platform, more specifically to a system and method for industry operating under government regulations such as commercial trucking industry.

Trucking is the primary mode of transporting goods in the United States. A variety of laws and regulations have been promulgated to regulate trucking activities as the trucking industry has grown. Under the U.S. Department of Transportation, the FMCSA (Federal Motor Carrier Safety Administration) has established a comprehensive list of regulations that a professional driver must comply with. These regulations govern the driver, the trucking company (aka carrier) and the truck.

Carriers are typically required to evaluate many aspects of truck drivers and their abilities to perform. It includes operator licensing and renewal, alcohol and drug testing, accident reporting, driver training, and hiring and screening of applicants. A driver is required to fill out an application to demonstrate their qualification. Information requested from the driver includes previous employment, identification information to begin the process of gathering information from third parties like government agencies and background checking companies.

Carriers must have up to 10 years of employment history on file for each driver including their previous drug and alcohol screenings, accidents, violations, and so on. The prospective employer may rely on fax or phone calls to gather this information from previous employers who may not have computerized means to respond. The increasingly sophisticated logistic industry needs better tools for the employment history verification.

Although there are software systems that assist commercial carriers in some aspects of the process, these systems, however, only address one part of the regulatory compliance puzzle and do not provide an integrated platform to electronically monitor and audit a carrier's compliance with federal and state regulations. Therefore, commercial carriers need a better tool to collect the information faster.

### SUMMARY OF THE INVENTION

In view of the foregoing background, the present invention offers a fast and efficient method and system for employment history verification, specifically designed for industry operating under government regulations such as commercial carriers.

The present invention implements a system in which carriers, drivers, and the operations team interact. The platform comprises Carriers, Users, Drivers, and Administration modules. The Carriers module is created when a carrier joins the platform. The Users module is provided for user account creation. The Drivers module is for a driver to submit his employment history verification application. The Administration module is used by the operations team to monitor and administer the operation of the platform.

The method includes steps of hiring a driver by a carrier. It starts with a carrier creating a profile for a driver candidate who is new to the platform. For an existing candidate, the candidate and the carrier identify the existing profile as the profile for the process. The driver candidate completes the verification authorization form and submits it to the carrier. The carrier then sends the verification form to the previous employer.

The previous employer is under a duty to respond to the requesting carrier within 30 days to satisfy the good faith requirement of the DOT regulation. The operations team keeps track of the process by sending a reminder to the non-responding employer every 7 days and keeps the records of the process for audit purposes.

It is expensive to send the employment verification form to the human resource department because employers with thousands of employees were required to dedicate a portion of their human resources department to the verification process. It is also time consuming for the requesting carrier waiting for the response from individual human resource department. Therefore, there is a need to integrate the whole process in a platform. These and other features and advantages of the present invention will become obvious to one skilled in the art.

### BRIEF DESCRIPTION OF DRAWINGS

FIG. 1 is a block diagram of functional modules of the platform.

FIG. 2 is a flow chart of the steps of employment verification.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiment set forth herein. Rather, these embodiments are provided so that this disclosure will be thorough and complete, and will fully convey the scope of the invention to those skilled in the art.

The present invention is an employment history verification platform for commercial trucking industry. The employment history verification process is governed by the regulation of the department of transportation (DOT). The safety performance information must be obtained from each DOT-regulated carrier for which the driver worked. The carriers must have on file 3 to 10 years of employment history for each driver including their previous drug and alcohol screenings, accidents, violations, and so on. The results of the investigation must be maintained in the employee's personnel file. If the new driver did not have any previous DOT driving history, that should also be noted and placed in his or her file.

Traditionally and currently practicing in some places, once a new driver signs the application and gives consent for the carrier to reach out to his previous employers. carriers use fax, email, or phone calls to gather this information. It takes a long time to get this information from all previous employers who the driver worked for. The idea of the present invention is to automate this process for the carriers. The invention is described as follows.

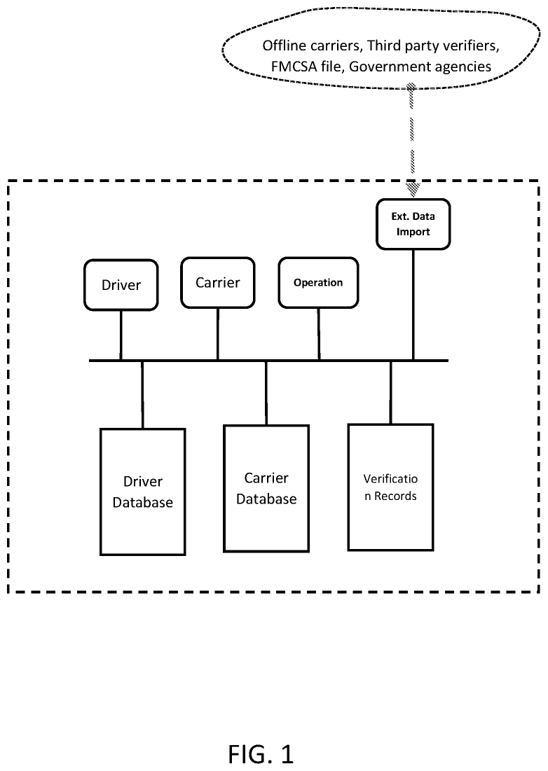

Referring to the block diagram of FIG. 1, the platform comprises information repositories for carriers, drivers, and verification records. The information is collected, updated, and used by functional blocks of driver, carrier, and operator of the platform. The information comes from the participants of the platform and external sources including non-participating carriers, third party information brokers, government agencies, and regularly updated FMCSA files.

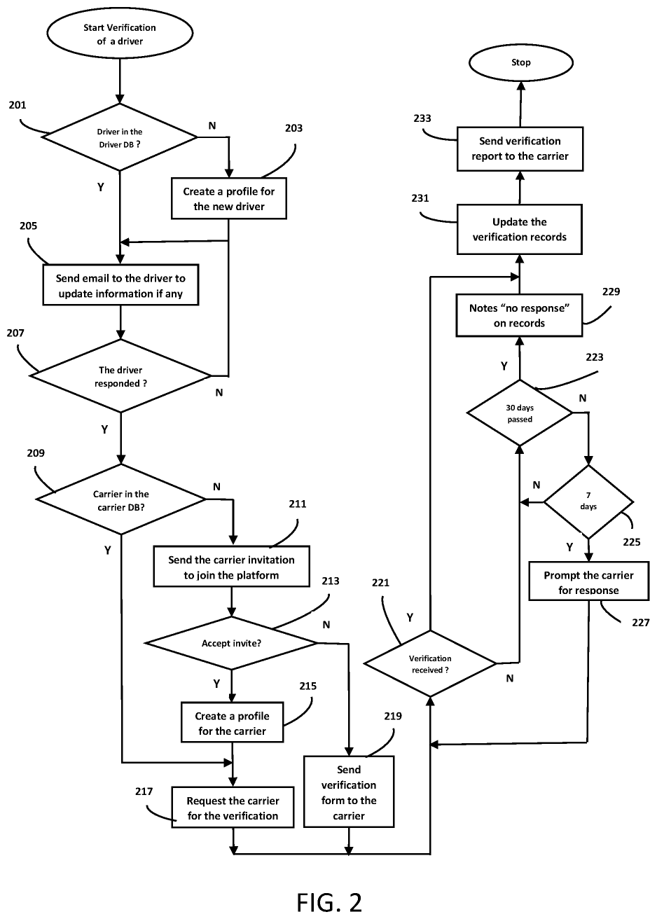

Referring to the process flow of FIG. 2, the verification process starts first checking if the driver is in the driver database as in the task 201. The task 203 creates a profile for a driver if the driver is not in the system. The task 205 sends an email with link to a web location where the driver can enter his/her personal information including past commercial trucking industry employment.

Once it receives information regarding carriers the driver used to work for, an operator of the platform checks if the carrier is in the system. If it is, the task 217 sends an email requesting employment verification for the driver. If the carrier is not in the system, an invitation to join the platform is sent to the carrier at block 211. If the carrier accepts the invitation, the operator creates a profile for the carrier. If the carrier either refuses to accept the invitation or does not respond, a verification request form is sent to the address registered with the DOT.

Once the request for verification is sent by the task 217 or by the task 219, it starts 30 day clock to keep track of the good faith requirements. The block 227 prompts non-responding carrier for response every 7 days. If a carrier responds to the request within 30 days, the system updates the verification record for the request. If no response is received in 30 days, it will keep a note of “no response” in the verification record. If a previous employer declines a request, they have to provide a reason for it (as per DOT regulations). This is recorded in the verification record as in block 231. Once the 30 days has passed, the requesting carrier will receive a verification report showing the employment records of the driver as in block 233.

Carrier accounts are created on the system if they subscribe to one of the subscriptions. There are 3 different types of subscriptions. With Basic subscription, a carrier can create up to 5 user accounts without a fee, and access to driver portal from which carriers have access to the previous employment verification history form that a driver filled in. With advance subscription, carriers have 5 year term of creating as many user accounts as they want and having full access to driver portal including access to the driver employment application. For carriers with advance subscription, the full application mechanism including policy document of the carrier, previous employment history form is available for drivers. The carrier can customize the form. With users subscription, carriers will be charged fee for additional user account.

An administration account is created as the carrier account is created in the system. The admin account is the very first account for the carrier. IF Someone from the same organization (carrier/transportation company) attempts to create a profile on the platform without being added by the admin user, a notification should be sent to the admin user of that same organization to approve the request or approve the new account for their team member.

When the carrier hires new driver, they will have the ability to search the driver in the system by using his or her full name DOB or last 4 of his SSN (social security number). At least 2 segments of the search have to be filled in order for the system to pull the driver information. If the driver is not in the system, then the carrier will have to add the driver. If the driver is in the system, the carrier will change the status on the driver's profile to “HIRED”, then a link will be automatically sent to the driver's email where he or she will be able to access the driver portal by login in if he already has an account) or to create an account if the new driver never used the platform. If the driver is in the system, once the search is completed and his or her name will appear, the carrier should have the ability to click on his or her profile where a dropdown menu will appear with all of the previous employers. Some of the drivers work for 2 employers at the same time, so this should be reflected when a request is pulled.

Carriers can add new drivers, terminate current drivers, and upload documents such as driver's licenses, and medical cards. Carrier will upload and keep the information for each driver up to date. Carriers can create profiles, using their basic information, on the platform-automated processes have to be in place for a faster and easier pull of information using the data files from FMCSA. Carriers will have the ability to create multiple users for the carrier and to bulk upload.

Previous employment verification form, qualification form and policies have to be signed by the driver. The carrier's name and information will be automatically added to the previous employment list of the driver after adding the driver and signing the policy and application. This will allow for more automatic processes and more accurate information to be shared.

Notifications should be sent to all profiles for each carrier automatically for expired driver's license, expired medical card. Every 30 days an email will be sent to the users to remind them that they have to check their drivers' profiles.

When carriers change the status to one of their current drivers to TERMINATED, they will have to make the final updates and make sure that they have all information on the driver's profile. Before terminating the profile, the system will ask the carrier to enter all their information and complete the profile in its entirety. Once the termination is completed, the driver profile will move from the ACTIVE module to the TERMINATED module of the platform. A warning should be displayed before the carrier proceeds with the termination. Carriers can always go back in and update information on their terminated drivers if needed. The carrier should have “active” and “terminated” modules on their profile for easier access.

When a driver applies for a position with a carrier, the driver fills in a job application. The carrier requests the operation to create an account for the driver. An email will be sent to the driver and the carrier once a request to create a driver profile is received by the operation. The driver has 72 hours to respond to this request. The driver uses the same credentials he used when he applied for employment with the carrier. The operations team will monitor the process and approve the request. The approval is sent to the carrier.

The carrier then creates an account for the driver and sends email to the driver with a link to the portal. The driver then completes a profile by entering his or her full name, email, and phone number, driver's license, medical card, employment history, and any incidents/accidents. If the driver is already in the system, the driver just logs in to access the account and update the information if necessary. The driver also provides consent for the carrier to reach out to the previous employers for employment verification. For carriers with advance subscription, the driver is able sign all policies for the carrier along with the employment application.

In providing the information of previous employment. the driver tries to locate carriers in the system. Once the driver finds the carrier, he just selects the carrier. Most of the information for the carrier, such as carrier name, address, DOT or MC number, phone, and email address, are readily available. If the carrier is not in the system, the driver should then add them to the system.

The operation module is involved in the processing of the employment verification. The following functionalities are built in the module for that purpose.

For security and additional layer of protection, the operations team has to approve the creation of a carrier before they are allowed to start using the platform.

The operations team monitors the process of creating a driver account after the carrier is allowed to create one. The driver has to initiate the creation of his own profile within 72 hours of getting notified of its allowance.

Most importantly, the operations team keeps track of employment verification process, and actively involved in encouraging the previous employers to comply with the government regulation. The operation module sends emails to the non-responding employers every 7 days for 30 days. All the activities are recorded in the system. The system sends a report of all these recorded activities to the carrier who requested the verification at the end of the 30 days. This report will serve as proof of good faith compliance with the regulation.

One skilled in the art, after being exposed to the teachings provided in the preceding descriptions and associated drawings, will likely conceive various modifications and alternative embodiments of the invention. Hence, it is important to note that the invention is not limited to the disclosed specific embodiments, and that modifications and alternative embodiments are intended to be encompassed within the scope of the appended claims.

Thus, the scope of the present disclosure is to be determined by the broadest permissible interpretation to the maximum extent allowed by law, of the following claims, and shall not be restricted or limited by the foregoing detailed description.

1. A system and method for employment history verification for industry operating under government regulations, comprising: carrier module; driver module; operation module; external data import module; carrier database; driver database; and verification records.

2. The carrier module of claim 1, wherein carriers administer employment records of their own employees, and respond to employment verification request.

3. The driver module of claim 1, wherein drivers administer their own employment history.

4. The operation module of claim 1, wherein the employment verification process operates.

5. The external data import module of claim 1, wherein external data are imported to the system.

6. The carrier database of claim 1, wherein data of the carrier and their employees are kept.

7. The driver database of claim 1, wherein the drivers' own employment history are kept.

8. The verification records of claim 1, wherein the records of employment verification processing incidents are kept.

9. The employment verification process of claim 4 comprises encouraging carriers to respond, recording steps taken, and safe-keeping the record for government audit.

10. The encouraging carriers of claim 9 comprises sending automatic reminders every 7 days for 30 days for unresponsive employer and raising alert.
